(19) United States
(12) Patent Application Publication
(10) Pub. No.: US 2024/0344708 A1
(43) Pub. Date: Oct. 17, 2024

(54) REMOVABLE CONTROL SYSTEM FOR A HEATING COIL OR COOKTOP

(71) Applicant: Haier US Appliance Solutions, Inc., Wilmington, DE (US)

(72) Inventors: Eugenio Gomez, Louisville, KY (US); James Lee Armstrong, Louisville, KY (US)

(21) Appl. No.: 18/300,876

(22) Filed: Apr. 14, 2023

(51) Int. Cl. F24C 7/08; F24C 7/06; H05B 3/68

(52) U.S. Cl. CPC F24C 7/083; F24C 7/067; H05B 3/68; H05B 2213/07

(57) ABSTRACT

A separable control assembly may include a support body, a device controller, a coil receptacle, and one or more male connector terminals. The support body may be attachable to the cooktop appliance. The device controller may be mounted to the support body. The coil receptacle may be mounted to the support body in electrical communication with the device controller. The coil receptacle may include one or more female connectors mounted to the support body and configured to receive one or more male coil terminals of the electric heating coil. The one or more male connector terminals may be mounted to the support body in electrical communication with the device controller to connect to a power receptacle.

### FIELD OF THE INVENTION

The present subject matter relates generally to cooktop appliances having a heating coil, and more particularly to systems and assemblies for controlling a heating coil.

### BACKGROUND OF THE INVENTION

Cooking appliances, such as, e.g., cooktops or ranges (also known as hobs or stoves), generally include one or more heated portions for heating or cooking food items within a cooking utensil placed on the heated portion. In the context of electric cooking appliances, one or more electric (e.g., resistive) heating coils is provided to output heat, which is transferred to the cooking utensil and thereby to any food item or items within the cooking utensil. Typically, a controller or other control mechanism, such as an electromechanical switch, regulates the heat output of the heating source selected by a user of the cooking appliance, e.g., by turning a knob or button. For example, the control mechanism may cycle the heating source between an activated or on state and a substantially deactivated or off state such that the average heat output of the heating source corresponds to the user-selected heat output level (i.e., predetermined power output).

Operating the electric heating elements at the predetermined power output corresponding to the selected heating level poses certain challenges. For example, the predetermined power input is only an indirect measurement of the actual cooking temperature. Some cooktop appliances employ a temperature sensor to directly measure the temperature of a cooking utensil or articles contained within the cooking utensil. The measured temperature may then be used to adjust the power output above or below the predetermined level in order to achieve a cooking temperature closer to the selected heating level. However, such systems are often expensive and must be installed during original assembly of cooking appliance. Moreover, most electric cooking appliances do not include any features or elements for controlling heat output based on detected temperature.

As a result, it would be useful to provide a system or assembly addressing one or more of the above issues. For instance, it may be advantageous to provide a system or assembly for providing temperature-based controls (e.g., even for cooking appliances not originally designed for such controls).

### BRIEF DESCRIPTION OF THE INVENTION

Aspects and advantages of the invention will be set forth in part in the following description, or may be obvious from the description, or may be learned through practice of the invention.

In one exemplary aspect of the present disclosure, a separable control assembly for selective interaction with a cooktop appliance comprising an electric heating coil is provided. The separable control assembly may include a support body, a device controller, a coil receptacle, and one or more male connector terminals. The support body may be attachable to the cooktop appliance. The device controller may be mounted to the support body. The coil receptacle may be mounted to the support body in electrical communication with the device controller. The coil receptacle may include one or more female connectors mounted to the support body and configured to receive one or more male coil terminals of the electric heating coil. The one or more male connector terminals may be mounted to the support body in electrical communication with the device controller to connect to a power receptacle.

In another exemplary aspect of the present disclosure, a separable control assembly for selective interaction with a cooktop appliance comprising an electric heating coil is provided. The separable control assembly may include a support body, a device controller, a temperature sensor, a coil receptacle, and a pair of male connectors. The support body may be attachable to the cooktop appliance. The device controller may be mounted to the support body. The temperature sensor may be in operable communication with the device controller. The coil receptacle may be mounted to the support body in electrical communication with the device controller. The coil receptacle may include a pair of female connectors mounted to the support body and configured to receive a pair of male coil terminals of the electric heating coil. The pair of male connector terminals may be mounted to the support body in electrical communication with the device controller to connect to a power receptacle.

The device controller may be configured to direct a responsive cooking operation including receiving a detected temperature signal from the temperature sensor and directing power to the electric heating coil through the coil receptacle based on the received detected temperature signal and a predetermined target temperature.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a cooktop appliance and assembly according to various exemplary embodiments of the present disclosure.

FIG. 2 provides a perspective view of a burner assembly according to exemplary embodiments of the present disclosure.

FIG. 3 provides a schematic view of a burner assembly according to exemplary embodiments of the present disclosure.

FIG. 4 provides a schematic view of a burner assembly according to exemplary embodiments of the present disclosure.

FIG. 5 provides a perspective view of a portion of the exemplary burner assembly of FIG. 4.

FIG. 6 provides a sectional perspective view of a portion of the exemplary burner assembly of FIG. 4.

FIG. 7 provides another schematic view of the exemplary burner assembly of FIG. 4.

FIG. 8 provides view of a mounted burner assembly according to exemplary embodiments of the present disclosure.

FIG. 9 provides a perspective view of a portion of the exemplary burner assembly of FIG. 8.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components or systems. For example, the approximating language may refer to being within a 10 percent margin (i.e., including values within ten percent greater or less than the stated value). In this regard, for example, when used in the context of an angle or direction, such terms include within ten degrees greater or less than the stated angle or direction (e.g., “generally vertical” includes forming an angle of up to ten degrees in any direction, such as, clockwise or counterclockwise, with the vertical direction V).

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

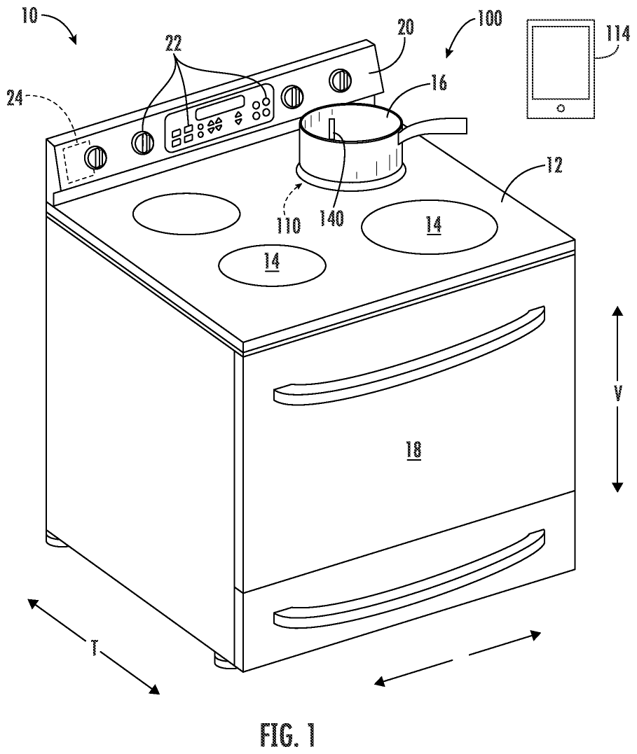

FIG. 1 provides a perspective view of an exemplary cooking assembly 100 that includes a separable or removable control assembly 110 used with a cooktop appliance 10.

Generally, cooktop appliance 10 defines a vertical direction V, a lateral direction L, and a transverse direction T. The vertical direction V, lateral direction L, and transverse direction T are mutually perpendicular and form an orthogonal direction system. As illustrated in FIG. 1, cooktop appliance 10 may be a range appliance that includes a horizontal cooking surface, such as a top panel 12, disposed on or vertically above an oven cabinet. However, cooktop appliance 10 is provided by way of example and is not intended to limit the present subject matter to any particular appliance or cooktop arrangement.

Top panel 12 may be constructed of any suitable material, e.g., a ceramic, enameled steel, or stainless steel. As shown in FIG. 1, top panel 12 of cooktop appliance 10 includes one or more heating assemblies 14. A cooking utensil 16 is shown placed or positioned on one of the heating assemblies 14 to cook or heat food items placed within cooking utensil 16. Cooking utensil 16 can be any suitable type of utensil, including e.g., pots, kettles, pans, skillets, or the like. For this embodiment, cooktop appliance 10 includes a door 18 that permits access to a cooking chamber (not labeled) of the oven cabinet of cooktop appliance 10. The cooking chamber is configured for cooking or baking food or other items placed therein.

Cooktop appliance 10 includes a user interface 20 having one or more control inputs 22 that permit a user to make selections for cooking of food items using heating assemblies 14 or the cooking chamber. As an example, a user may manipulate one or more control inputs 22 to select, e.g., a power or heat output setting for each heating assembly 14. The selected heat output setting of heating assembly 14 affects the heat transferred to cooking utensil 16 positioned on heating assembly 14. Although shown on a backsplash or back panel of cooktop appliance 10, user interface 20 may be positioned in any suitable location, e.g., along a front edge of the appliance 10. Control inputs 22 may include one or more buttons, knobs, or touch screens, as well as combinations thereof.

Cooktop appliance 10 also includes a controller 24 operably connected, e.g., electrically coupled, to user interface 20 or control inputs 22. Generally, operation of cooktop appliance 10, including heating assemblies 14, may be controlled by controller 24. In some embodiments, controller 24 is a processing device and may include a microprocessor or other device that is in operable communication with components of cooktop appliance 10, such as heating assembly 14. Controller 24 may include a memory and microprocessor, such as a general or special purpose microprocessor operable to execute programming instructions or micro-control code associated with a selected heating level, operation, or cooking cycle. The memory may represent random access memory such as DRAM, or read only memory such as ROM or FLASH. In some embodiments, the processor executes programming instructions stored in memory. The memory may be a separate component from the processor or may be included onboard within the processor.

Alternatively, controller 24 may be constructed without using a microprocessor, e.g., using a combination of discrete analog or digital logic circuitry (such as switches, amplifiers, integrators, comparators, flip-flops, AND gates, and the like) to perform control functionality instead of relying upon software. Control inputs 22 and other components of cooktop appliance 10 may be in communication with (e.g., electrically coupled to) controller 24 via one or more signal lines or shared communication busses. Moreover, heating assemblies 14 may be operably connected to controller 24, e.g., directly or indirectly through one or more respective terminal pairs.

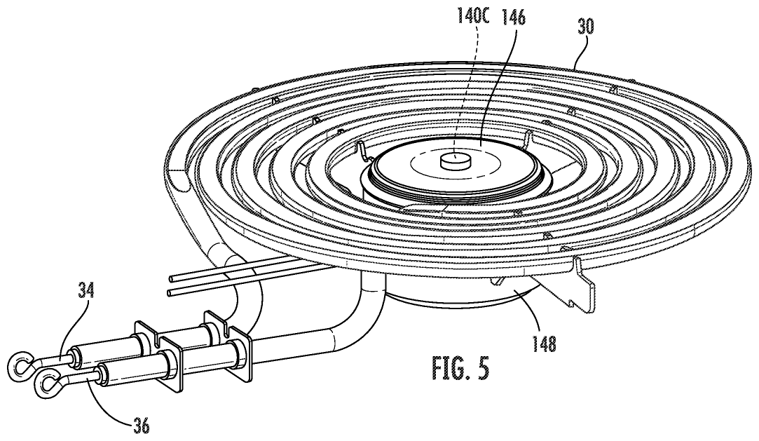

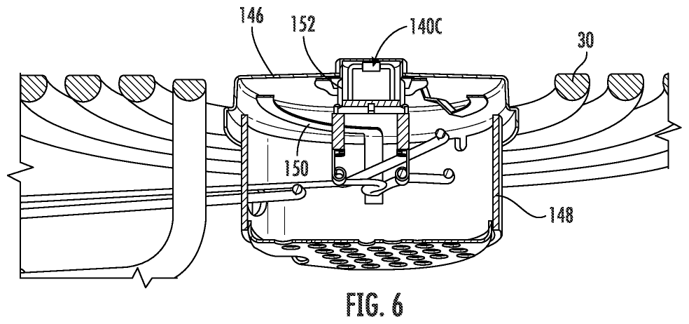

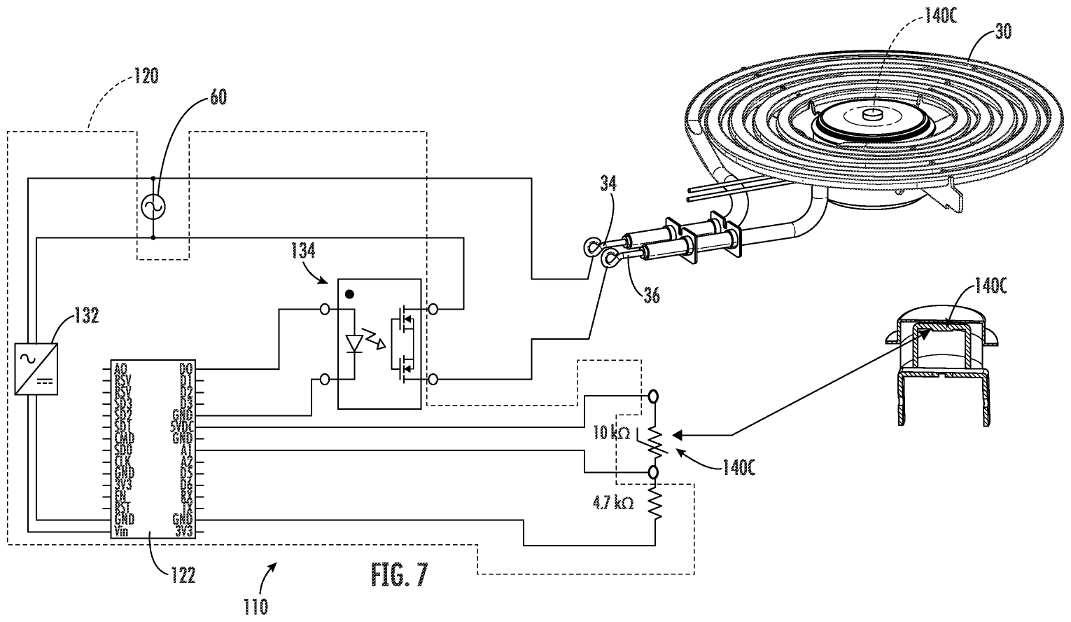

Referring generally to FIGS. 1 through 8, one or more heating assembly 14 includes one or more electric heating elements 30. Generally, operation of heating assemblies 14 may be regulated such that a heat output of at least one heating assembly 14 is based on, at least in part, a command or signal from controller 24. In particular, controller 24 may be in electrical communication with a power source 60 to selectively limit the power, current, or voltage to a heating assembly 14. In this regard, controller 24 may at least partially direct a heat output selected by a user of cooktop appliance 10. Moreover, a user of cooktop appliance 10 may, for example, manipulate a control 22 associated with a heating assembly 14 to select a desired heat output.

For example, one or more electric heating elements 30 may be alternately cycled between an activated state and a deactivated state, i.e., between on and off, such that the average heat output over each cycle can correspond to or approximates a selected heat output. That is, a duty cycle of heating element 30 may be controlled such that, based on the user's selection, heating element 30 is activated or turned on for a fraction or portion of the duty cycle and deactivates or turns off heating element 30 for the remainder of the duty cycle. A user of cooktop appliance 10 may, e.g., manipulate a control 22 associated with a heating assembly 14 to select a desired heat output or temperature for heating element 30 of the associated heating assembly 14. The selection by the user indicates what fraction or portion of the duty cycle heating element 30 should be activated or on, e.g., if the user selects the midpoint heat output, the duty cycle of heating element 30 may be controlled such that heating element 30 is on for half of the duty cycle and off for half of the duty cycle.

As illustrated, some heating assembly 14 embodiments include an electric heating element 30 defining a heat zone. For instance, electric heating element 30 may be a single spiral shaped resistive coil for providing heat to a cooking utensil 16 positioned thereon. In some such embodiments, heating assembly 14 utilizes an exposed, electrically-heated, planar coil that is helically-wound about a center point. Coils act as a heat source, i.e., as electric heating element 30, for heating cooking utensils 16 placed directly on heating assembly 14.

A first prong or terminal 34 and a second prong or terminal 36 are provided for heating element 30. An electrical current may be transmitted to a resistive coil at the terminals 34, 36. When a voltage differential is applied across first and second terminals 34, 36 of the resistive coil, a temperature of electric heating element 30 increases. Resistive coil may be a CALROD® coil in certain example embodiments.

Although controller 24 may generally control or limit power, current, or voltage to a heating assembly 14 (e.g., at the heating element 30), one or more further or more specific control devices may be provided via the control assembly 110, as will be described in greater detail below.

Generally, control assembly 110 includes a support body 120 supporting a device controller 122. As shown, support body 120 generally provides a box or frame that is selectively attachable to cooktop appliance 10. For instance, support body 120 may include one or more solid, nonpermeable walls defining an enclosure cavity. Optionally, one or more mounting brackets 124 may be fixed on or relative to the walls of support body 120. For instance, mounting brackets 124 may extend radially outward from support body 120 to receive one or more mechanical fasteners (e.g., one or more bolt, screw, nut, clip, etc.) configured to attach support body 120 to cooktop appliance (e.g., at a bottom surface of top panel 12 or on a wall of the cabinet).

In some embodiments, device controller 122 is fixed relative to support body 120, such as by one or more mechanical fasteners, adhesives, solders, or welds. As the support body 120 is moved (e.g., attached or removed from top panel 12), device controller 122 may thus also move. Optionally, device controller 122 may be housed within support body 120, such as within closed cavity.

In some embodiments, device controller 122 is a processing device and may include a microprocessor. Device controller 122 may include a memory and microprocessor, such as a general or special purpose microprocessor operable to execute programming instructions or micro-control code associated with a selected heating level, operation, or cooking cycle. The memory may represent random access memory such as DRAM, or read only memory such as ROM or FLASH. In some embodiments, the processor executes programming instructions stored in memory. The memory may be a separate component from the processor or may be included onboard within the processor of device controller 122.

In electrical communication with device controller 122, multiple conductors or electrical connectors may be provided on support body 120. For instance, one or more (e.g., a pair of) male connector terminals 126 may be mounted to support body 120 (e.g., to move therewith, at least in part). Generally, such male terminals 126 are electrically connected to (i.e., in electrical communication with) device controller 122, such as through one or more wires or conductor paths. In some embodiments, the male connector terminals 126 generally match (e.g., have substantially the same size, shape, form, etc.) as the first terminal 34 or the second terminal 36. In turn, the male connector terminals 126 may be accepted in place of the first terminal 34 and the second terminal 36 within a power receptacle 62 that is mounted to the cabinet or top panel 12 and electrically coupled to a power source 60 or controller 24.

Separate from or in addition to male connector terminals 126, a coil receptacle 128 may be mounted to the support body 120 (e.g., to move therewith, at least in part). As shown, the coil receptacle 128 may be spaced apart from support body 120 (e.g., while remaining connected via one or more resilient or flexible wires). Generally, such a coil receptacle 128 includes one or more female slots 130 that hold conductors that are electrically connected to (i.e., in electrical communication with) device controller 122, such as through one or more wires or conductor paths. In some embodiments, the coil receptacle 128 (or at least the female slots 130 thereof) generally matches (e.g., have substantially the same size, shape, form, etc.) as the power receptacle 62. In turn, the coil receptacle 128 may receive the first terminal 34 and second terminal 36 therein in place of the power receptacle 62 that is mounted to the cabinet or top panel 12 and electrically coupled to a power source 60 or controller 24.

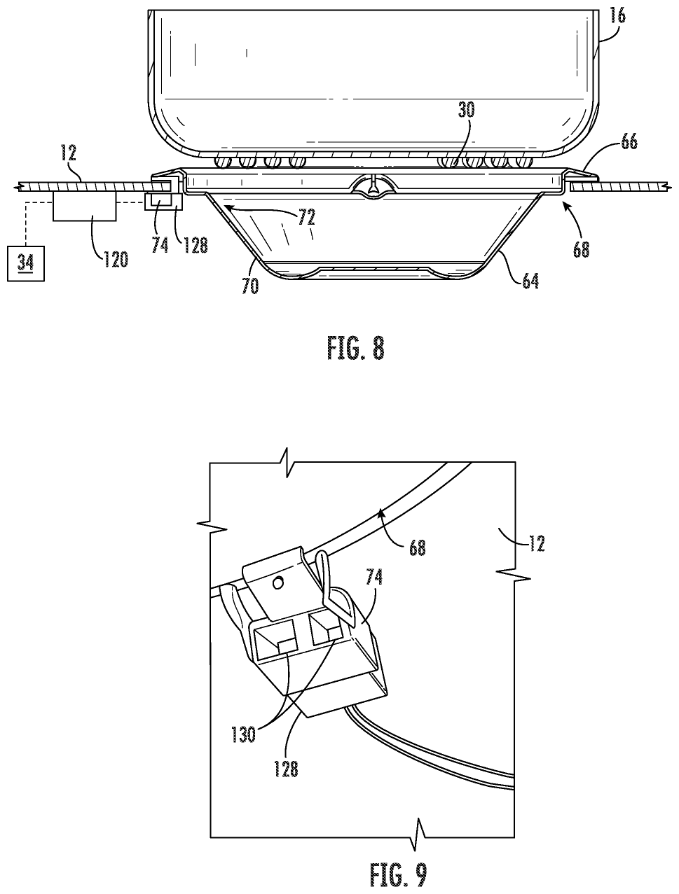

Turning briefly to FIGS. 8 and 9, in some embodiments, coil receptacle 128 may be mounted to top panel 12 proximal or adjacent to heating assembly 14 (e.g., apart or separate from support body 120). For instance, coil receptacle 128 may be mounted below top panel 12. In some such embodiments, a drip pan 64 is attached, e.g., removably attached, to panel 12 below electric heating element 30. For instance, drip pan 64 may include a support lip 66 extending along a circumferential direction to rest on a top surface of panel 12, e.g., about a hole 68 defined beneath electric heating element 30. A concave sidewall 70 may extend below from support lip 66 or otherwise below panel 12. As shown, a receptacle clip 74 fixed (e.g., relative to the cabinet, top panel 12, or heating assembly 14) beside drop bowl, such as by a clasp arm or other mechanical fastener. The receptacle clip 74 may be aligned with an aperture 72 defined horizontally through the concave sidewall 70. When assembled, coil receptacle 128 is selectively received on the receptacle clip 74. The terminals 34, 36 of electric heating element 30 may thus be received through the aperture 72 and within coil receptacle 128.

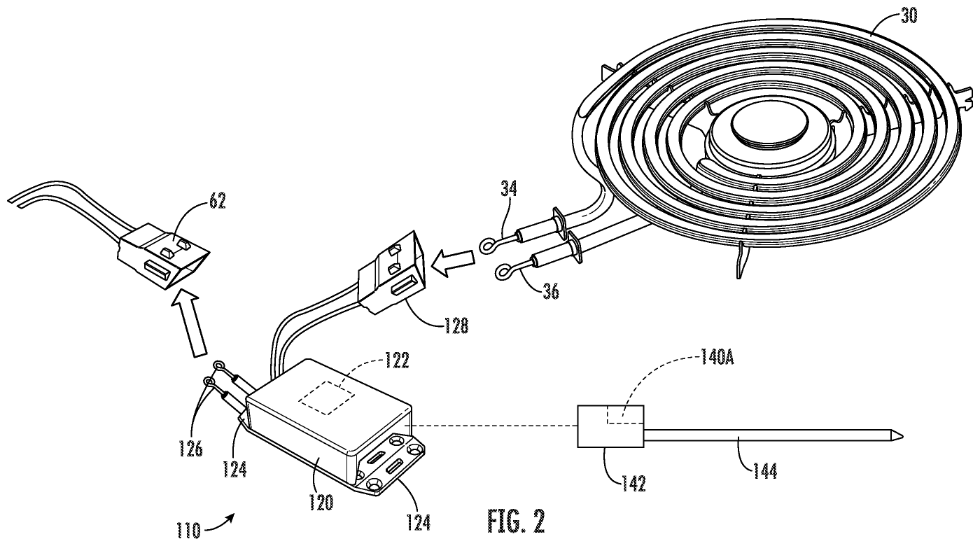

Returning generally to FIGS. 2 through 8, in addition to device controller 122, one or more additional modules may be mounted to support body 120 (e.g., separate from or as a portion of device controller 122). In some embodiments, an AC/DC power supply 132 is mounted to support body 120, such as by one or more mechanical fasteners, adhesives, solders, or welds. Specifically, AC/DC power supply 132 may be disposed in electrical communication with device controller 122. For instance, AC/DC power supply 132 may be included on a circuit connecting or electrically coupled to power source 60 or controller 24. Generally, AC/DC power supply 132 includes or is provided as any suitable module or circuit for converting AC current (e.g., 240V provided from power source 60 or controller 24) to DC current, as would be understood. In turn, AC power supplied to and through power receptacle 62 may be transformed to a suitable DC current powering device controller 122.

In certain embodiments, one or more switch modules 134 is mounted to support body 120, such as by one or more mechanical fasteners, adhesives, solders, or welds. Specifically, switch module 134 is disposed in electrical communication with device controller 122 and coil receptacle 128. Switch module 134 may include or be provided as any suitable switch or power-limiting module (e.g., open-closed switch, TRIAC, etc.) to selectively limit power therethrough (e.g., according to a prescribed duty cycle or percentage output). The electrical position or state (e.g., open-closed or set percentage output). During use, switch module 134 may be adjusted (e.g., open-closed or limited-increased) as directed by the device controller 122 to selectively limit power to the electric heating element 30.

In additional or alternative embodiments, a wireless module 136 is mounted to support body 120, such as by one or more mechanical fasteners, adhesives, solders, or welds. Specifically, switch module 134 is disposed in electrical communication with device controller 122. For instance, wireless module 136 can be an onboard component of device controller 122 or it can be a separate, off board component. Generally, wireless module 136 is configured to communicate device controller 122 with one or more nodes over a wireless network (such as a Bluetooth communication network), a wireless local area network (WLAN), a point-to point communication networks (such as radio frequency identification networks, near field communications networks, etc.), or a combination of two or more of the above communications networks. In some such embodiments, device controller 122 is configured to receive one or more signals from a separate device or module spaced apart from support module. For instance, device controller 122 may be configured to receive instructional inputs from a remote device 114 spaced apart from the support body 120 and in wireless communication with the device controller 122 through the wireless module 136. Such a remote device 114 may be provided as, for example, a personal computing device (e.g., laptop or desktop), a mobile computing device (e.g., smartphone or tablet), a gaming console or controller, a wearable computing device, an embedded computing device, a remote, or any other suitable type of user computing device.

In further additional or alternative embodiments, one or more temperature sensors 140 is connected (e.g., via a wired or wireless connection) to device controller 122. Such temperature sensors 140 may be spaced apart from support body 120 while still being generally associated with the heating assembly 14 or electrical heating element 30 to which device controller 122 is connected. During use, device controller 122 may thus receive one or more temperature signals corresponding to temperature at or around electric heating element 30.

As an example, and turning especially to FIG. 2, device controller 122 may be in electrical communication with a wired temperature sensor 140A. Wired temperature sensor 140A may include a thermocouple, a bimetal thermostat, a thermistor, a resistive temperature device (RTD), or any other device (e.g., held within a sensor housing 152) suitable for measuring the temperature of food products. A temperature probe 144 may be coupled to or included with wired temperature sensor 140A (e.g., to be received within a food item or utensil 16). When assembled, wired temperature sensor 140A may be coupled to support body 120 via one or more flexible or resilient wires. In turn, wired temperature sensor 140A may be movable relative to the support body 120 while still being in electrical communication with the device controller 122 to transmit one or more temperature signals from wired temperature sensor 140B to device controller 122.

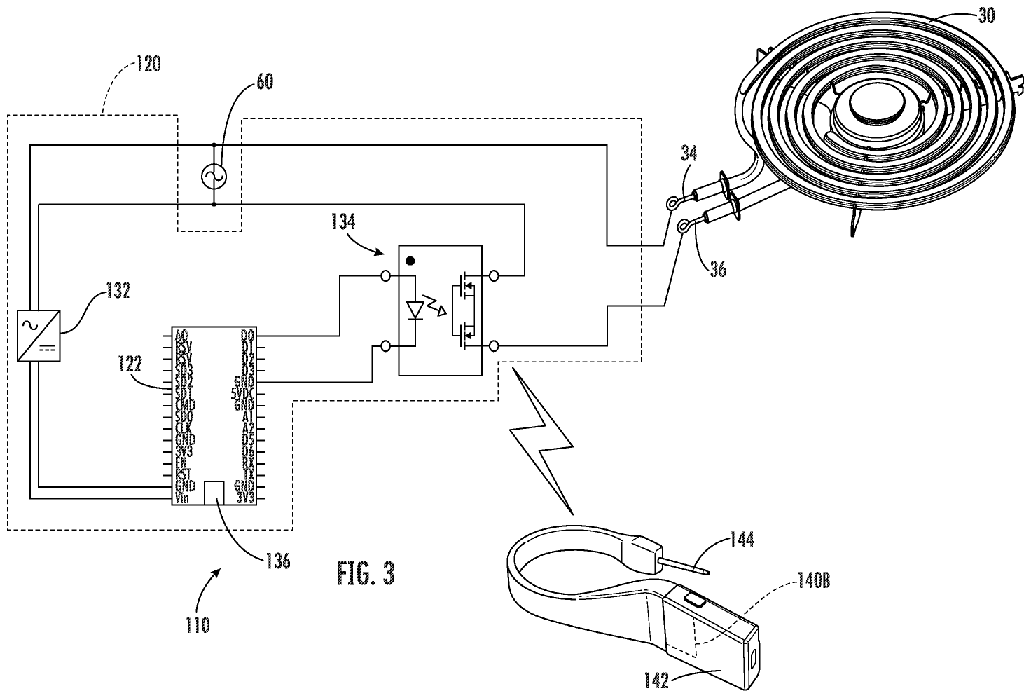

As an additional or alternative example, and turning especially to FIG. 3, device controller 122 may be in wireless communication with a wireless temperature sensor 140B. Wireless temperature sensor 140B may include a thermocouple, a bimetal thermostat, a thermistor, a resistive temperature device (RTD), or any other device (e.g., held within a sensor housing 152) suitable for measuring the temperature of food products or a utensil 16 (e.g., to which wireless temperature sensor 140B is mounted or within which wireless temperature sensor 140B is embedded). A temperature probe 144 may be coupled to or included with wireless temperature sensor 140B (e.g., to be received within a food item or utensil 16). Additionally or alternatively, a sensor controller or wireless module may be provided, as would be understood, to communicate detected temperature signals to device controller 122. When assembled, wireless temperature sensor 140B may be unattached to support body 120. In turn, wireless temperature sensor 140B may be movable relative to the support body 120 while still being in wireless communication with the device controller 122 to transmit one or more temperature signals from wired temperature sensor 140B to device controller 122.

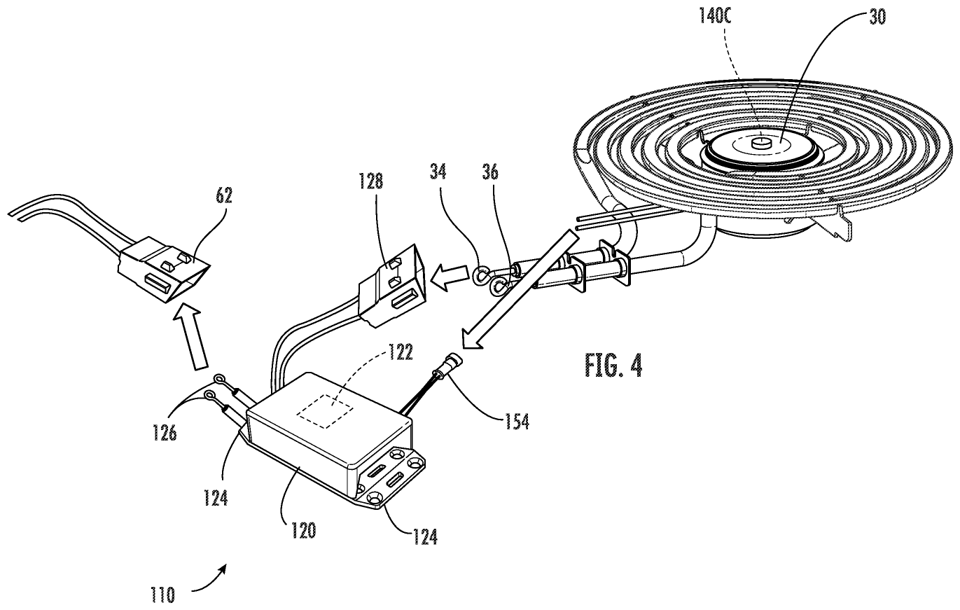

As another additional or alterative example, and turning especially to FIGS. 4 through 7, device controller 122 may be in electrical communication with a wired fixed temperature sensor 140C. Wired temperature sensor 140A may include a thermocouple, a bimetal thermostat, a thermistor, a resistive temperature device (RTD), or any other device (e.g., held within a sensor housing 152) suitable to detect a temperature at a utensil 16 (e.g., supported on electric heating element 30). As shown, wired fixed temperature sensor 140C may be mounted on or with heating assembly 14. For instance, wired fixed temperature sensor 140C may be coaxially mounted relative to the electric heating element 30. Moreover, wired fixed temperature sensor 140C can be disposed in biased engagement to be biased above a top surface of electric heating element 30 (e.g., to contact a bottom surface of a utensil 16 thereof). For instance, wired fixed temperature sensor 140C may be attached to a mounting plate or shroud cover 146 (e.g., via mechanical fasteners, welds, etc.), which is itself supported by a spring bracket 150 (e.g., held within a shroud 148 extending about the spring bracket 150 or wired fixed temperature sensor 140C). When assembled, wired temperature sensor 140C may be in electrical communication with the device controller 122 to transmit one or more temperature signals from wired fixed temperature sensor 140C to device controller 122. For instance, a wire harness 154 may be mounted to the support body 120 (e.g., to move therewith, at least in part). As shown, the wire harness 154 may be spaced apart from support body 120 (e.g., while remaining connected via one or more resilient or flexible wires). Generally, such a wire harness 154 includes one or more male/female plugs to mate with a corresponding harness fixed to wired fixed temperature sensor 140C. In turn, the wire harness 154 may act as the connection point between one or more wires from temperature sensor 140C and support body 120 or device controller 122.

Returning generally to FIGS. 1 through 8, device controller 122 may be configured to direct a responsive cooking operation that relies on temperatures detected at one or more temperature sensors 140 (e.g., 140A, 140B, 140C as described above). The responsive cooking operation may include receiving one or more detected temperature signals (e.g., from a temperature sensor 140A, 140B, 140C), and directing power to the electric heating element 30 through the coil receptacle 128 based on the received detected temperature signal and a predetermined target temperature (e.g., preset or input by a user). Such power direction may be effectuated, for instance, by setting the corresponding input to “HIGH” or “Maximum Heat” (e.g., from a predetermined range of settings further including a “LOW” or “Minimum Heat”) then selectively adjusting the switch module 134 (e.g., in a closed loop) according to the received temperature signals. During operation, the device controller 122 may thus receive the measured temperature data from the temperature sensor 140A, 140B, 140C before selectively restricting or energizing electric heating element 30) to maintain a desired temperature of a food item or utensil 16 responsive to the measured temperature from the temperature sensor 140A, 140B, 140C. In this manner, device controller 122 may receive instantaneous feedback (e.g., independent of the controller 24) regarding the actual temperature, resulting in closed loop feedback. Device controller 122 may then adjust electric heating element 30 to ensure the temperature is precisely controlled to match the desired cooking temperature or a specific cooking temperature profile.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A separable control assembly for selective interaction with a cooktop appliance comprising an electric heating coil, the separable control assembly:
a support body attachable to the cooktop appliance;
a device controller mounted to the support body;
a coil receptacle mounted to the support body in electrical communication with the device controller, the coil receptacle comprising one or more female connectors mounted to the support body and configured to receive one or more male coil terminals of the electric heating coil; and
one or more male connector terminals mounted to the support body in electrical communication with the device controller to connect to a power receptacle.

2. The separable control assembly of claim 1, further comprising an AC/DC power supply mounted to support body disposed in electrical communication with the device controller.

3. The separable control assembly of claim 1, further comprising a switch module mounted to the support body in electrical communication with the device controller and the coil receptacle to selectively limit power to the electric heating coil.

4. The separable control assembly of claim 1, further comprising a drip bowl disposed below the electric heating coil, the drip bowl comprising a bowl body and a receptacle clip fixed beside the bowl body, wherein the coil receptacle is selectively received on the receptacle clip.

5. The separable control assembly of claim 1, further comprising a wireless module mounted to support body disposed in electrical communication with the device controller.

6. The separable control assembly of claim 5, further comprising a temperature sensor spaced apart from the support body in wireless communication with the device controller through the wireless module to transmit one or more temperature signals to the device controller.

7. The separable control assembly of claim 5, wherein the device controller is configured to receive instructional inputs from a remote device spaced apart from the support body and in wireless communication with the device controller through the wireless module.

8. The separable control assembly of claim 1, further comprising a temperature sensor movable relative to the support body and in electrical communication with the device controller to transmit one or more temperature signals thereto.

9. The separable control assembly of claim 8, wherein the temperature sensor is coaxially mounted relative to the electric heating coil.

10. The separable control assembly of claim 1, wherein the device controller is configured to direct a responsive cooking operation comprising
receiving a detected temperature signal, and
directing power to the electric heating coil through the coil receptacle based on the received detected temperature signal and a predetermined target temperature.

11. A separable control assembly for selective interaction with a cooktop appliance comprising an electric heating coil, the separable control assembly:
a support body attachable to the cooktop appliance;
a device controller mounted to the support body;
a temperature sensor in operable communication with the device controller;
a coil receptacle mounted to the support body in electrical communication with the device controller, the coil receptacle comprising a pair of female connectors mounted to the support body and configured to receive a pair of male coil terminals of the electric heating coil; and
a pair of male connector terminals mounted to the support body in electrical communication with the device controller to connect to a power receptacle
wherein the device controller is configured to direct a responsive cooking operation comprising
receiving a detected temperature signal from the temperature sensor, and
directing power to the electric heating coil through the coil receptacle based on the received detected temperature signal and a predetermined target temperature.

12. The separable control assembly of claim 11, further comprising an AC/DC power supply mounted to support body disposed in electrical communication with the device controller.

13. The separable control assembly of claim 11, further comprising a switch module mounted to the support body in electrical communication with the device controller and the coil receptacle to selectively limit power to the electric heating coil.

14. The separable control assembly of claim 11, further comprising a drip bowl disposed below the electric heating coil, the drip bowl comprising a bowl body and a receptacle clip fixed beside the bowl body, wherein the coil receptacle is selectively received on the receptacle clip.

15. The separable control assembly of claim 11, further comprising a wireless module mounted to support body disposed in electrical communication with the device controller.

16. The separable control assembly of claim 15, wherein the temperature sensor is spaced apart from the support body in wireless communication with the device controller through the wireless module to transmit one or more temperature signals to the device controller.

17. The separable control assembly of claim 15, wherein the device controller is configured to receive instructional inputs from a remote device spaced apart from the support body and in wireless communication with the device controller through the wireless module.

18. The separable control assembly of claim 11, wherein the temperature sensor is movable relative to the support body and in electrical communication with the device controller to transmit one or more temperature signals thereto.

19. The separable control assembly of claim 18, wherein the temperature sensor is coaxially mounted relative to the electric heating coil.
